(19) United States
(12) Patent Application Publication
(10) Pub. No.: US 2006/0001002 A1
(43) Pub. Date: Jan. 5, 2006

(54) Refrigerating cycle

(75) Inventors: Shigeki Iwanami, Okazaki-city (JP); Shigeru Kawano, Chiryu-city (JP); Teruhiko Kameoka, Okazaki-city (JP); Shozo Ikejima, Okazaki-city (JP); Takashi Honda, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/169,638

(22) Filed: Jun. 30, 2005

(30) Foreign Application Priority Data
Jun. 30, 2004 (JP) 2004-193557

(51) Int. Cl. C09K 5/00

(52) U.S. Cl. 252/68

(57) ABSTRACT

A refrigerating cycle comprising a compressor 1 which compresses and discharges a refrigerant containing a refrigerating machine oil in a refrigerant circulating passage for lubricating the compressor 1, wherein fine particles 17 having a nearly circular shape in cross section are put into the refrigerant circulating passage. The fine particles 17 present between the sliding surfaces of the compressor prevent direct contact between the sliding surfaces. Besides, the fine particles 17 having a nearly circular shape in cross section roll when the opposing side surfaces move relative to each other creating rolling friction. Therefore, the coefficient of friction decreases on the sliding portions of the compressor 1.

### BACKGROUND OF THE INVENTION

1. Field of the Invention

The present invention relates to a refrigerating cycle in which a refrigerating machine oil, for lubricating a compressor, is contained in a refrigerant circulating passage, and to a refrigerating machine oil and a refrigerant used in the refrigerating cycle.

2. Description of the Related Art

The refrigerating cycle is so constituted as to effect cooling and heating by circulating a coolant by using a compressor and by exchanging heat between the refrigerant and air that is blown through a heat exchanger. A refrigerating machine oil is contained in the refrigerant circulating passage of the refrigerating cycle in order to maintain the lubrication for the compressor and the sealing of the refrigerant in the step of compression. The refrigerating machine oil is circulated through the refrigerant circulating passage together with the refrigerant to maintain the durability and the performance of the compressor.

The refrigerating cycle utilizes the condensation/vaporization of the refrigerant. When the refrigerating cycle is discontinued, therefore, the refrigerant is liquefied in the compressor to wash away the refrigerating machine oil; i.e., the refrigerating machine oil flows out of the compressor. At the time of re-start, after being left to stand, in particular, the refrigerating machine oil exists in very small amounts on the sliding portions of the compressor placing the slide portions of the compressor in a poorly lubricated state posing a problem in that seizure may take place on the sliding portions of the compressor, before the refrigerating machine oil that has left of the compressor returns back to the compressor, and that the compressor itself cannot be operated.

To cope with this, a method has been known to provide a mechanism for preventing the refrigerating machine oil from flowing out of the compressor accompanied, however, by a problem of causing the structure of the compressor to become complex.

In recent years, furthermore, a system has been put into practice using a carbonic acid as the refrigerant from the environmental point of view requiring, however, an operation pressure which is much higher than that of the conventional freon refrigerant, and this presents a serious problem of maintaining lubrication on the slide portions.

In addition to the use as the refrigerating cycle, there have also been known to mix fine particles into the lubricating oil for improving the lubricating performance (see, for example, JP-A-2002-213436) and to mix fine particles into the grease or the engine oil for improving the lubricating performance (see, for example, JP-A-5-171169).

In the refrigerating cycle, furthermore, there have been known to mix fine particles to the refrigerant in order to improve the transmission of heat (see, for example, U.S. Pat. No. 6,432,320) and to mix fine particles to the refrigerating machine oil to improve the transmission of heat (see, for example, JP-A-2004-85108).

However, disclosed in U.S. Pat. No. 6,432,320 and JP-A-2004-85108 is to mix fine particles into the refrigerant or into the refrigerating machine oil in order to improve the transmission of heat as described above, and the fine particles are not those suited for improving the lubricating performance. With those disclosed in U.S. Pat. No. 6,432,320 and JP-A-2004-85108, therefore, it is impossible to prevent the seizure of the compressor when the compressor is in a poorly lubricated state or in a high-load state in the refrigerating cycle.

### SUMMARY OF THE INVENTION

In view of the above-mentioned points, it is an object of the present invention to provide a refrigerating cycle which features excellent reliability by preventing seizure of the compressor even when the compressor is in a poorly lubricated state or in a high-load state in the refrigerating cycle.

In order to achieve the above object according to one aspect of the present invention, there is provided a refrigerating cycle comprising a compressor (1) which compresses and discharges a refrigerant containing a refrigerating machine oil in a refrigerant circulating passage for lubricating the compressor (1), wherein fine particles (17) having a nearly circular shape in cross section are put into the refrigerant circulating passage.

Therefore, the fine particles present between the slide surfaces of the compressor prevent direct contact between the slide surfaces. Besides, the fine particles having a nearly circular shape in cross section undergo the rolling when the opposing side surfaces move relative to each other creating a rolling friction. Therefore, the coefficient of friction decreases on the slide portions of the compressor preventing the seizure of the compressor even in a poorly lubricated state or a high-load state.

According to the present invention, the fine particles (17) have any one of a circular shape, an elliptic shape or a polygonal shape in cross section.

When the opposing slide surfaces move relative to each other, therefore, the fine particles roll reliably.

According to the present invention, the fine particles (17) comprise any one of C60, C70, carbon nano-tubes, carbon nano-horns or clustered diamond.

According to the present invention, the fine particles (17) have a size of several hundred pm to 100 nm.

According to another aspect of the present invention, there is provided a refrigerating machine oil for lubricating a compressor (1) in a refrigerating cycle containing therein fine particles (17) of nearly a circular shape in cross section.

By using the refrigerating machine oil containing the fine particles in the refrigerating cycle, there is obtained the same effect as that of the above invention.

According to the present invention, the fine particles (17) mixed into the refrigerating machine oil have any one of a circular shape, an elliptic shape or a polygonal shape in cross section.

By using the refrigerating machine oil containing the fine particles in the refrigerating cycle, there is obtained the same effect as that of the above invention.

According to the present invention, the fine particles (17) mixed into the refrigerating machine oil comprise any one of C60, C70, carbon nano-tubes, carbon nano-horns or clustered diamond.

According to the present invention, the fine particles (17) have a size of several hundred pm to 100 nm.

According to a further aspect of the present invention, there is provided a refrigerant compressed by a compressor (1) in a refrigerating cycle containing therein fine particles (17) of nearly a circular shape in cross section.

By using the refrigerant in the refrigerating cycle, there is obtained the same effect as that of the above invention.

According to the present invention, the fine particles (17) mixed into the refrigerant have any one of a circular shape, an elliptic shape or a polygonal shape in cross section.

By using the refrigerant in the refrigerating cycle, there is obtained the same effect as that of the above invention.

According to the present invention, the fine particles (17) mixed into the refrigerant comprise any one of C60, C70, carbon nano-tubes, carbon nano-horns or clustered diamond.

According to the present invention, the fine particles (17) mixed into the refrigerant have a size of several hundred pm to 100 nm.

The present invention will be more fully understood from the description of preferred embodiments of the invention as set forth below together with the accompanying drawings.

### BRIEF DESCRIPTION OF THE DRAWINGS

In the drawings:

FIG. 1 is a diagram illustrating a refrigerating cycle according to an embodiment of the present invention;

FIG. 2 is a view illustrating a layout for mounting the refrigerating cycle of FIG. 1 on a vehicle;

FIG. 3 is a sectional view of a compressor in FIG. 1;

FIG. 4 is a sectional view illustrating, on an enlarged scale, a major portion of the compressor of FIG. 3;

FIG. 5 is a graph illustrating the results of testing;

FIG. 6 is a graph illustrating the results of testing; and

FIG. 7 is a perspective view of a device for evaluation used in the testing.

### DESCRIPTION OF THE PREFERRED EMBODIMENTS

An embodiment of the present invention will now be described.

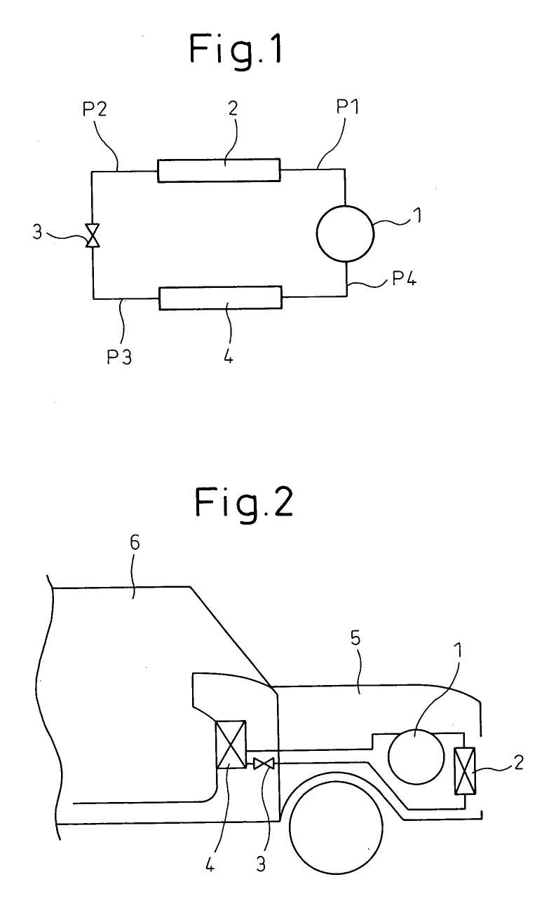

A refrigerating cycle of FIG. 1 is constituted in the same manner as that of a known one in which a compressor sucks and compresses a gas phase refrigerant into a highly compressed state. The compressor 1 will be described later.

The high-pressure refrigerant discharged from the compressor 1 flows into a condenser 2 passing through a refrigerant pipe P1, and the condenser 2 condenses the refrigerant by radiating the heat of the refrigerant into the external air. The refrigerant of the liquid phase as a result of condensation flows into an expansion valve 3 through a refrigerant pipe P2. The expansion valve 3 squeezes the area of the passage through which the refrigerant passes to reduce the pressure of the refrigerant.

The refrigerant of a reduced pressure flows into an evaporator 4 through a refrigerant pipe P3. The evaporator 4 absorbs heat from the air blown into the compartment. Here, the refrigerant vaporizes due to the heat that is absorbed and is put in the gas phase state. The gas phase refrigerant flowing out from the evaporator 4 is sucked again by the compressor 1 through a refrigerant pipe P4 and is compressed.

The compressor 1, condenser 2, expansion valve 3, evaporator 4 and refrigerant pipes P1 to P4 constitute a refrigerant circulating passage of the present invention.

The refrigerating cycle is mounted on a vehicle in a layout as shown in FIG. 2, the compressor 1 and condenser 2 being arranged in an engine room 5, and the evaporator being arranged in a passenger compartment 6.

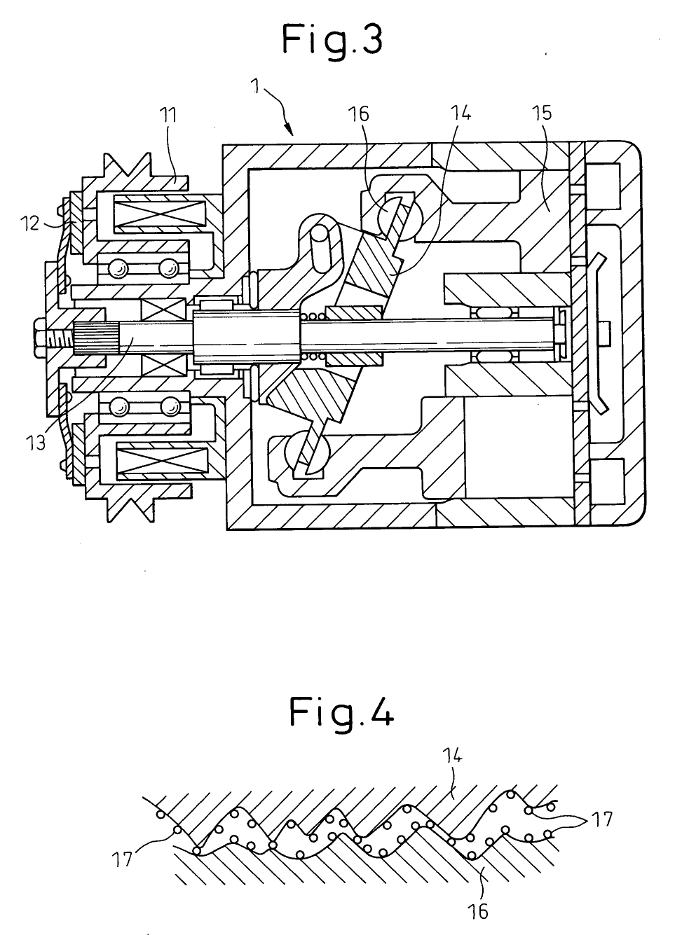

Referring to FIG. 3, the compressor 1 is a known swash plate-type compressor. The power is transmitted to a pulley 11 from an internal combustion engine (not shown) of the vehicle through a belt (not shown), the rotation of the pulley 11 is transmitted to a rotary shaft 13 via a clutch plate 12, and a swash plate 14 rotates together with the rotary shaft 13.

The swash plate 14 is coupled to a plurality of pistons 15 through shoes 16. The swash plate 14 and the shoes 16 undergo a sliding motion accompanying the rotation of the swash plate 14 causing the pistons 15 to be reciprocally moved. Due to the reciprocating motion of the pistons 15, the gas phase refrigerant is sucked, compressed and is discharged.

In the refrigerant circulating passage of the refrigerating cycle, there are contained an HFC (hydrofluorocarbon) 134a which is a freon-type refrigerant as well as a refrigerating machine oil for improving the sealing of the compressor 1 and for lubricating the sliding portions.

The refrigerating machine oil contains fine particles having nearly a circular shape in cross section and an average particle size in cross section of several hundred pm to 100 nm. As the fine particles, there can be used C60 which is one of fullerenes. C60 has nearly a spherical shape and an average particle size of about 700 pm. The refrigerating machine oil is contained in the compressor 1 at the time of assembling the refrigerating cycle.

In the above-mentioned constitution, when the compressor 1 is driven by the internal combustion engine of the vehicle to start the operation of the refrigerating cycle, the refrigerant is compressed by the compressor 1, and is fed into the condenser 2 with pressure. The pressure is, then, reduced through the expansion valve 3, and the refrigerant is returned back to the compressor 1 through the evaporator 4 to repeat the cycle. At this time, the refrigerating machine oil that is contained circulates through the refrigerant circulating passage together with the refrigerant to maintain the sealing and lubrication for the compressor 1.

When the operation of the refrigerating cycle is discontinued in this state, the refrigerating machine oil remains in the compressor 1 in an amount that can stay therein and maintains the lubrication until the refrigerating machine oil that is outside the compressor 1 returns back to the compressor 1 when the compressor 1 is next driven.

Here, if the refrigerating cycle remains in the halted state for several days to several weeks, the refrigerant is condensed in the compressor 1 when its temperature is low due to a temperature differential between day and night, and dilutes the refrigerating machine oil left in the compressor 1. After the compressor 1 is filled with refrigerant due to the condensation, the refrigerant overflows from the compressor 1 to the exterior, whereby the refrigerating machine oil is carried away from the compressor 1, the refrigerant is condensed again in the compressor 1 and overflows repetitively. Due to the above repetition, the refrigerating machine oil remains in very small amounts in the compressor 1.

Even when the refrigerating machine oil is left in very small amounts in the compressor 1 as described above, numerous fine particles 17 exist between the slide surfaces of the swash plate 14 and the shoes 16 to prevent a direct contact between the slide surfaces. Further, the fine particles 17 having a nearly circular shape in cross section undergo the rolling when the swash plate 14 and the shoes 16 move relative to each other creating a rolling friction. Therefore, the coefficient of friction decreases on the slide portions of the swash plate 14 and the shoes 16 preventing the seizure.

The fine particles 17 have particle sizes which are very smaller than the few μm of the surface roughness of the slide surface of the compressor 1, and exhibit the effect of preventing the seizure without causing adverse effects such as wear on the sliding surfaces or an increase of friction.

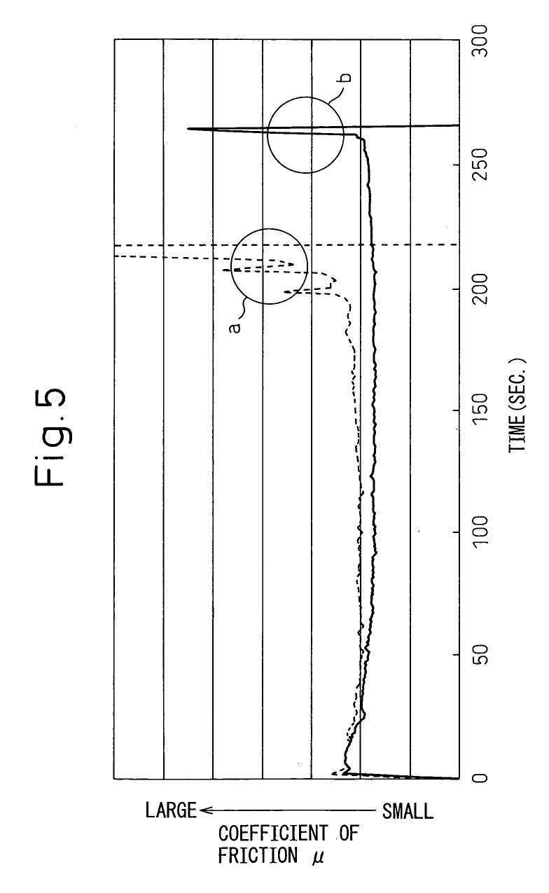

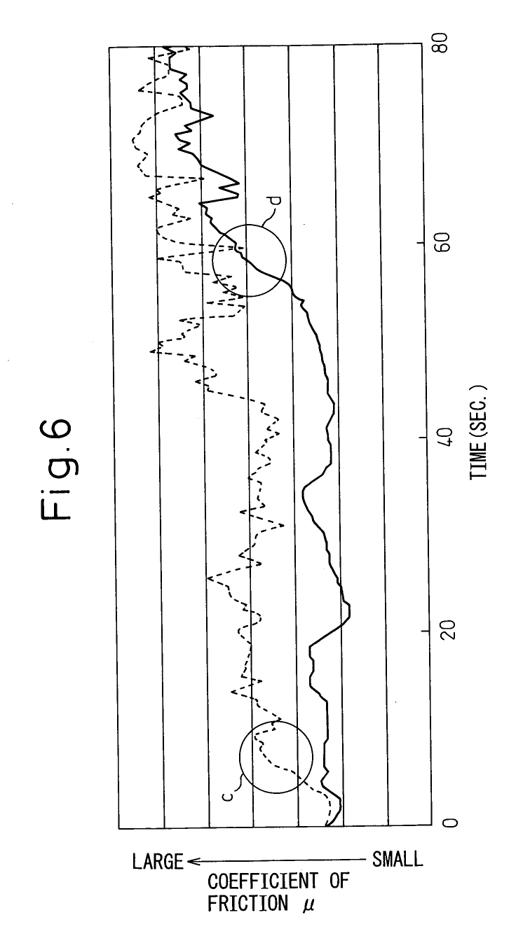

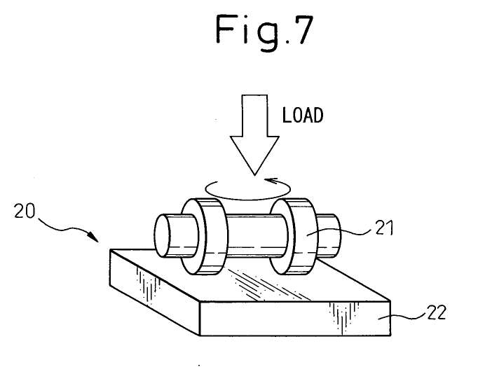

FIGS. 5 and 6 show the results of testing conducted to make sure the effects. The testing was conducted by using a device 20 for evaluation shown in FIG. 7. Concretely speaking, cylindrical test pieces 2 were pushed with a predetermined load onto a plate 22, an engine oil or a refrigerating machine oil was applied in very small amounts onto the plate 22, the test pieces 21 were turned to slide the test pieces 21 and the plate 22, thereby to measure the coefficient of friction between the test pieces 21 and the plate 22. The refrigerating machine oil used in the testing was a polyalkyl group glycol (PAG) type refrigerating machine oil.

In FIG. 5, a broken line represents the results of using an engine oil to which C60 was not added. In this case, the coefficient of friction remained stable with the passage of time during the initial period, and the seizure occurred at a moment (a) when the oil has run out after the passage of time of about 210 seconds.

In FIG. 5, a solid line represents the results of using the engine oil to which C60 was added. In this case, the coefficient of friction remained stable with the passage of time during the initial period, and the seizure occurred at a moment (b) when the oil has run out after the passage of time of about 260 seconds.

As described above, when C60 was added to the engine oil, the coefficient of friction has decreased to a slight decrease as compared to that of the engine oil to which C60 was not added. The coefficients of friction, however, were nearly the same. Besides, the time until the seizure took place was extended by only a small degree. Namely, in the case of the engine oil, the addition of C60 did not produce much difference.

In FIG. 6, a broken line represents the results of using the refrigerating machine oil to which C60 was not added. In this case, the coefficient of friction has increased sharply at a moment (c) when about 10 seconds have passed, the coefficient of friction varying sharply indicating a symptom of seizure. In FIG. 6, a solid line represents the results of using the refrigerating machine oil to which C60 was added. In this case, the coefficient of friction has increased sharply at a moment (d) when about 60 seconds have passed indicating a symptom of seizure.

When C60 was added to the refrigerating machine oil, as described above, the coefficient of friction was suppressed from varying and the time was greatly extended before there appeared a symptom of seizure. This manifests the effect of the addition of fine particles such as C60 to the refrigerating machine oil.

In the above embodiment, fine particles were mixed into the refrigerating machine oil. In refrigerating cycle, however, the refrigerant is liquefied on the downstream of the condenser 2 and is compatible with the refrigerating machine oil. Therefore, the effect is exhibited even if the fine particles have been mixed into the refrigerant in advance.

In the above embodiment, further, C60 was used as the fine particles. However, there can be used fine particles of any shape that easily undergo the rolling, such as the fine particles of a circular shape, an elliptic shape or a polygonal shape in cross section. Concretely, there can be used the fine particles of the shape of a football or an ellipse, such as C70. Or there can be used carbon nano-tubes or carbon nano-horns having a circular shape in cross section or clustered diamond of a polygonal shape in cross section. In the case of the polygonal shape, it is desired that the number of corners is not smaller than five. Further, a plurality of kinds of fine particles may be mixed.

C60 and C70 comprise 60 carbon atoms and have the shape of a soccer ball. The shapes of C60 and C70 are close to a sphere as compared to that of the diamond, and contribute to further decreasing the coefficient of friction of the slide portions of the compressor.

When the fine particles cannot be easily dispersed in the refrigerating machine oil, the fine particles may be coated on the outer surfaces thereof with an affinity-imparting agent to exhibit affinity to the refrigerating machine oil.

Though the above embodiment has used an HFC (hydrofluorocarbon) 134a as the refrigerant, there can be further used a carbonic acid gas refrigerant (CO₂), a refrigerant R410 which is a mixture of R32 and R125, or a mixed refrigerant of a mixture of two or more kinds of the refrigerants.

As the refrigerating machine oil, further, there can be used a polyalkyl group glycol (PAG) type refrigerating machine oil, a polyol ester (POE) type refrigerating machine oil, a mineral oil, an alkylbenzene, a polyvinyl ether (PVE) type refrigerating machine oil or a polyalphaolefin (PAO) type refrigerating machine oil.

While the invention has been described by reference to specific embodiments chosen for purposes of illustration, it should be apparent that numerous modifications could be made thereto, by those skilled in the art, without departing from the basic concept and scope of the invention.

1. A refrigerating cycle comprising a compressor (1) which compresses and discharges a refrigerant containing a refrigerating machine oil in a refrigerant circulating passage for lubricating the compressor (1), wherein fine particles having a nearly circular shape in cross section are put into said refrigerant circulating passage.

2. A refrigerating cycle according to claim 1, wherein said fine particles have any one of a circular shape, an elliptic shape or a polygonal shape in cross section.

3. A refrigerating cycle according to claim 1, wherein said fine particles comprise any one of carbon nano-tubes, carbon nano-horns or clustered diamond.

4. A refrigerating cycle according to claim 1, wherein said fine particles comprise C60 or C70.

5. A refrigerating cycle according to claim 1, wherein said fine particles have a size of several hundred pm to 100 nm.

6. A refrigerating machine oil for lubricating a compressor in a refrigerating cycle containing therein fine particles of nearly a circular shape in cross section.

7. A refrigerating machine oil according to claim 6, wherein said fine particles mixed into the refrigerating machine oil have any one of a circular shape, an elliptic shape or a polygonal shape in cross section.

8. A refrigerating machine oil according to claim 6, wherein said fine particles mixed into the refrigerating machine oil comprise any one of carbon nano-tubes, carbon nano-horns or clustered diamond.

9. A refrigerating machine oil according to claim 6, wherein said fine particles mixed into the refrigerating machine oil comprise C60 or C70.

10. A refrigerating machine oil according to claim 6, wherein said fine particles mixed into the refrigerating machine oil have a size of several hundred pm to 100 nm.

11. A refrigerant compressed by a compressor in a refrigerating cycle containing therein fine particles of nearly a circular shape in cross section.

12. A refrigerant according to claim 11, wherein said fine particles mixed into the refrigerant have any one of a circular shape, an elliptic shape or a polygonal shape in cross section.

13. A refrigerant according to claim 11, wherein said fine particles mixed into the refrigerant comprise any one of carbon nano-tubes, carbon nano-horns or clustered diamond.

14. A refrigerant according to claim 11, wherein said fine particles mixed into the refrigerant comprise C60 or C90.

15. A refrigerant according to claim 11, wherein said fine particles mixed into the refrigerant have a size of several hundred pm to 100 nm.
